(19) United States
(12) Patent Application Publication
(10) Pub. No.: US 2019/0014810 A1
(43) Pub. Date: Jan. 17, 2019

(54) Encapsulated Oil for Powdered Instant Food Products

(71) Applicant: General Mills, Inc., Minneapolis, MN (US)

(72) Inventors: Goeran WALTHER, Plymouth, MN (US); Ben HEITKE, Corcoran, MN (US); Bernhard VAN LENGERICH, Plymouth, MN (US)

(73) Assignee: General Mills, Inc., Minneapolis, MN (US)

(21) Appl. No.: 16/069,742

(22) PCT Filed: Jan. 12, 2016
(86) PCT No.: PCT/US2016/012954

§ 371 Date: Jul. 12, 2018

(51) Int. Cl. A23P 10/35; A23P 10/47; A23L 33/00; A23L 33/12

(52) U.S. Cl. CPC A23P 10/35; A23P 10/47; A23V 2002/00; A23L 33/12; A23L 33/40

(57) ABSTRACT

An encapsulated product including solid particles of a matrix in which discrete, film coated oil droplets are embedded is provided. The matrix includes a continuous phase in which a discrete phase of the matrix and the oil droplets are embedded. The encapsulated product disintegrates readily in water or an aqueous solution.

### BACKGROUND

Various polyunsaturated fatty acids (PUFAs), such as docosahexaenoic acid (DHA), eicosapentaenoic acid (EPA), and arachidonic acid (ARA), are believed to have an important role in health and development in infants, and are regarded as part of a healthy diet in adults. However, PUFAs and other unsaturated fatty acids are susceptible to degradation, for example, in the presence of oxygen or heat due to their unsaturated nature. The inclusion of unsaturated fatty acids in dry foods, therefore, has the challenge of preventing substantial degradation of the unsaturated fatty acids due to drying, oxygen exposure, and/or heating during preparation or storage of the dry food.

### SUMMARY

The present disclosure relates to particles including an encapsulated oil for inclusion in dried foods that readily disintegrate when hydrated.

An encapsulated product is provided. In an embodiment, the encapsulated product comprises solid particles having an average diameter of 0.15-0.5 mm, with a length to diameter ratio of up to 1.2, where each particle includes discrete, film coated oil droplets in an amount of from 5% to 25% by weight of the particle; and a matrix having a continuous phase in an amount of from 25% to 57% by weight of the particle, the continuous phase including a water soluble carbohydrate, a water soluble protein, a water soluble gum, or a combination thereof, the protein content of the continuous phase comprising no more than 16% by weight of the particle, and a dispersed phase including an uncooked starch, an insoluble fiber, or a combination thereof in an amount of from 27% to 65% by weight of the particle, the continuous phase having embedded in it discrete pieces of the dispersed phase and the film coated oil droplets, where the encapsulated product has a fineness of less than 250 μm, or less than 200 μm, when evaluated using the infant formula fineness test or flows through a nipple having a 0.27 mm opening when evaluated using an infant formula nipple flow test. In some embodiments, the encapsulated product has a fineness of less than 250 μm when evaluated using the infant formula fineness test and flows through a nipple having a 0.27 mm opening when evaluated using an infant formula nipple flow test.

In some embodiments, the continuous phase can further include a softener selected from glycerol, inositol, high fructose corn syrup, honey, and a combination thereof in an amount of about 1-7% by weight of the particle. In some embodiments, the continuous phase can further include an antioxidant or component that improves the effect of an antioxidant selected from ascorbic acid, sodium ascorbate, citric acid, sodium citrate, potassium citrate, calcium citrate, erythorbic acid, and combinations thereof.

In some embodiments, the continuous phase can include pre-gelatinized starch, maltodextrin, whey protein, a caseinate, or a combination thereof.

In some embodiments, the film of the film coated droplets can include whey protein, a caseinate, a plant protein, a gum, or a combination thereof.

In some embodiments, the continuous phase can include whey protein, and the film of the film coated oil droplets contains substantially no caseinate. In some embodiments, the continuous phase can include whey protein, and includes inositol in an amount of about 1-7% by weight of the particle. In some embodiments, the continuous phase can include a water soluble carbohydrate, and includes glycerol in an amount of about 1-7% by weight of the particle, and contains substantially no protein.

In some embodiments, the dispersed phase can include an uncooked starch that is a thin boiling starch. In some embodiments, the dispersed phase can include an uncooked starch that has a granule size of less than 100 μm.

In some embodiments, the oil droplets can include docosahexaenoic acid (DHA), arachidonic acid (ARA), eicosapentaenoic acid (EPA), alpha-linolenic acid (ALA), an oil-soluble vitamin, or a combination thereof.

In some embodiments, the matrix includes no fat component.

In some embodiments, the encapsulated product contains no dairy ingredients.

In another embodiment, the encapsulated product comprises solid particles having an average diameter of 0.15-0.5 mm, with a length to diameter ratio of up to 1.2, where each particle includes discrete, film coated oil droplets in an amount of from 5% to 20% by weight of the particle; and a matrix having a continuous phase in an amount of from 30% to 42% by weight of the particle, the continuous phase including a water soluble carbohydrate, a water soluble protein, or a combination thereof, the protein content of the continuous phase comprising no more than 10% by weight of the particle, and a dispersed phase including an uncooked starch in an amount of from 42% to 62% by weight of the particle, the continuous phase having embedded in it discrete pieces of the dispersed phase and the film coated oil droplets, where the encapsulated product has a fineness of less than 250 μm, or less than 200 μm, when evaluated using the infant formula fineness test or flows through a nipple having a 0.27 mm opening when evaluated using an infant formula nipple flow test. In some embodiments, the encapsulated product has a fineness of less than 250 μm when evaluated using the infant formula fineness test and flows through a nipple having a 0.27 mm opening when evaluated using an infant formula nipple flow test.

In some embodiments, the encapsulated product can have an Oxipres stability that is at least 13 hours or at least 18 hours.

In another embodiment, the encapsulated product comprises solid particles having an average diameter of 0.15-0.5 mm, with a length to diameter ratio of up to 1.2, where each particle includes discrete, film coated oil droplets in an amount of from 5% to 25% by weight of the particle, the film coating the oil droplets comprising whey or a caseinate; and a matrix having a continuous phase in an amount of from 25% to 57% by weight of the particle, the continuous phase having a protein content of no more than 16% by weight of the particle, and including a water soluble carbohydrate, a water soluble protein, a water soluble gum, or a combination thereof when the film comprises whey, or a pregelatinized starch, a water soluble protein, a water soluble gum, or a combination thereof, and substantially no whey protein when the film comprises a caseinate; and a dispersed phase including an uncooked starch, an insoluble fiber, or a combination thereof in an amount of from 27% to 65% by weight of the particle, the continuous phase having embedded in it discrete pieces of the dispersed phase and the film coated oil droplets, where the encapsulated product has a fineness of less than 250 μm, or less than 200 μm, when evaluated using an infant formula test. In some embodiments, the encapsulated product has a fineness of less than 250 μm when evaluated using the infant formula fineness test and flows through a nipple having a 0.27 mm opening when evaluated using an infant formula nipple flow test.

In another embodiment, the encapsulated product comprises solid particles having an average diameter of 0.15-0.5 mm, with a length to diameter ratio of up to 1.2, where each particle includes discrete, film coated oil droplets in an amount of from 5% to 35% by weight of the particle; and a matrix having a continuous phase in an amount of from 17% to 57% by weight of the particle, the continuous phase including a water soluble carbohydrate, a water soluble protein, a water soluble gum, or a combination thereof, the protein content of the continuous phase comprising no more than 16% by weight of the particle, and a dispersed phase including a component that is not plasticized during extrusion at a temperature at or below 50° C., the dispersed phase included in an amount of from 22% to 65% by weight of the particle, the continuous phase having embedded in it discrete pieces of the dispersed phase and the film coated oil droplets, where the encapsulated product has a fineness of less than 250 μm when evaluated using the infant formula fineness test or flows through a nipple having a 0.27 mm opening when evaluated using an infant formula nipple flow test. In some embodiments, the encapsulated product has a fineness of less than 250 μm when evaluated using the infant formula fineness test and flows through a nipple having a 0.27 mm opening when evaluated using an infant formula nipple flow test.

In another embodiment, the encapsulated product comprises solid particles having an average diameter of 0.15-0.5 mm, with a length to diameter ratio of up to 1.2, where each particle includes discrete, film coated oil droplets; and a matrix having a continuous phase, the continuous phase including a water soluble carbohydrate, a water soluble protein, a water soluble gum, or a combination thereof, and a dispersed phase including a component that is not plasticized during extrusion at a temperature at or below 50° C., the continuous phase having embedded in it discrete pieces of the dispersed phase and the film coated oil droplets, where the encapsulated product has a fineness of less than 250 μm when evaluated using the infant formula fineness test or flows through a nipple having a 0.27 mm opening when evaluated using an infant formula nipple flow test. In some embodiments, the encapsulated product has a fineness of less than 250 μm when evaluated using the infant formula fineness test and flows through a nipple having a 0.27 mm opening when evaluated using an infant formula nipple flow test.

In some embodiments, the oil content is from 5% to 35%, the continuous phase is in an amount of from 17% to 57%, and the dispersed phase is in an amount of from 22% to 65%.

In some embodiments, the continuous phase is in an amount of from 25% to 57% by weight of the particle, and the dispersed phase is in an amount of from 27% to 65% by weight of the particle.

A powdered instant dry food product including an encapsulated product described herein is provided. The powdered instant dry food product can be an infant formula. The powdered instant dry food product can be a dry soup mix, a gravy mix, an instant dried mashed potato, an instant pudding or other instant dessert mix, a porridge, a baby porridge, an instant smoothie powder mix, a hot cocoa mix, dry milk, or oat meal.

These and various other features and advantages will be apparent from a reading of the following detailed description.

### DETAILED DESCRIPTION

A diet that includes unsaturated fats, particularly polyunsaturated fatty acids (PUFAs) has been implicated in reducing inflammation and lowering risk of heart disease. In addition, some PUFAs, such as docosahexaenoic acid (DHA) and arachidonic acid (ARA), have been found to be relatively concentrated in the brain and eye. Further, DHA and ARA are found in breast milk and are thought to convey benefits to nursing infants.

As a result of these and other benefits, many foods have been supplemented with various unsaturated fatty acids. However, due to the instability of unsaturated fatty acids, especially in the presence of oxygen or heat, benefits from the inclusion of unsaturated fatty acids may be lost, or undesired off-notes may develop as a result of oxidation reactions of the PUFAs during food preparation and/or storage over time. In order to address this issue, unsaturated fatty acids have been processed in ways that are designed to reduce exposure to either oxygen or heat during processing or storage. Such processing includes spray drying of an oil-in-water emulsion, which can protect oil droplets from the emulsion from the presence of oxygen with a matrix formed from a water soluble material present in the water phase of the emulsion, but can also expose PUFAs to heat during the spray drying process itself. In some cases, PUFAs have been added after spray drying of non-PUFA containing emulsified oil droplets (U.S. Pat. No. 6,428,832), but then the PUFAs remain exposed on the surface of the spray dried product, potentially exposing the PUFAs to oxygen during storage. As described in “Microencapsulation of Fish Oil” (Beindorff and Zuidam, “Encapsulation Technologies for Active Food Ingredients and Food Processing”, Ch. 6, Zuidam and Nedovic, Eds., 2010), various other methods have been used to avoid lipid oxidation during spray drying. In one example, nitrogen can be used instead of regular air during spray drying. In another method, relatively low temperature spray drying processes can be used. Low temperature spray drying depends on a two-step procedure, which includes an initial spray drying step and a subsequent drying step using a belt dryer, a fluidized bed dryer, or spray-drying of encapsulated droplets onto a carrier powder (e.g., maltodextrin or starch). However, both the use of a nitrogen atmosphere for spray drying and low temperature, two step spray drying increase the manufacturing costs significantly.

In other cases, Beindorff and Zuidam (2010) describe methods using extrusion where unsaturated oils have been encased as droplets in matrices, which can protect the oils from oxygen and can be made without exposing the oils to excess heat. Such extruded matrix-protected oil droplets also have a benefit of being able to be extruded into particles which have a controllable size and shape, allowing for uniform and predictable utility and function. However, it has been discovered that making extruded matrix-protected oil droplet particles present a particular challenge for powdered foods that are intended to be reconstituted for consumption. Such particles must not only protect an encapsulated oil from oxygen exposure and degradation during storage, but they must also readily disintegrate in water without requiring excess heat, mixing or shearing energy, or time before consumption. If included in infant formula, additional challenges include a restricted list of ingredients allowed in infant formulas, and the ability to pass through a baby bottle nipple, without compromising the protection and stability of the encapsulated oil during storage. If included in other powdered food products, an encapsulated oil-containing particle cannot present excess grittiness so as to provide an unpleasant eating experience.

As disclosed herein, it has been discovered that an oil can be encapsulated in particles as discrete, film coated oil droplets embedded in a matrix, which provides advantages of readily disintegrating in water while also providing sufficient protection of the oil droplets from oxidation during storage. Thus, provided herein is an encapsulated product comprising particles that protect an oil from oxidation yet readily disintegrate in water in order to be useful in a powdered instant food product that is intended to be reconstituted for consumption. In some embodiments, an encapsulated product provided herein can include a PUFA that is stable for at least 6 months (e.g., at least 18 months) at room temperature in a regular air environment. Stability of a PUFA in an encapsulated product can be measured using Oxipres analysis at 90° C. and a pure oxygen atmosphere at 5 bars. Each 5.5 hour period of oxidative stability measured by Oxipres analysis is equivalent to oxidative stability of about 6 months at room temperature in a regular air environment. Thus, an oxidative stability of 11 hours as measured by Oxipres analysis is equivalent to about 12 months oxidative stability at room temperature in a regular air environment.

An encapsulated product provided herein disintegrates in water sufficiently to make it suitable for inclusion in a dried food product intended to be reconstituted for consumption, such as a dried instant food powder used in infant formula. An encapsulated product provided herein has a relatively dense, non-porous matrix, as compared to a matrix in a spray dried product, which contributes to chemical stability of the encapsulated oil. However, though the matrix is relatively dense and non-porous, the matrix of an encapsulated product provided herein includes a water soluble continuous phase, within which are embedded oil droplets and a non-water soluble dispersed matrix phase. Without being bound to theory, it is believed that the dispersed phase provides areas of interruptions and tensions in the continuous phase, which promote disintegration and hydration of the encapsulated product upon exposure to water. Disintegration and hydration of the matrix can result in a liquid or mass containing smaller matrix pieces that allow for flow through a nipple and/or a minimally gritty texture.

In order to test disintegration, an encapsulated product is evaluated using an infant formula test to determine fineness of the encapsulated particles or whether the encapsulated product can flow through a nipple. As used herein, an infant formula test for determining fineness of an encapsulated product includes combining an encapsulated product with an infant formula at a ratio of 13.5 g encapsulated product to 186.5 g infant formula to produce a fortified infant formula composition containing DHA and/or ARA. Four unpacked, level scoops (approximately 35 g) of the fortified infant formula composition is then combined with 23 g of hot water at 200° F. and stirred by hand in a cup until no clumps are present to reconstitute the fortified infant formula composition having a pourable consistency and a viscosity similar to melted chocolate. At 5 minutes, the reconstituted infant formula composition is then spread on a 0-30 mil Hegman gage to determine fineness of the encapsulated product included in the fortified infant formula composition. Fineness can be measured in any appropriate scale and units, including mils or microns. In some embodiments, an encapsulated product can have a fineness of 10 mils or less (e.g., 8 mils or less), or a fineness of 250 μm or less (e.g., 200 μm or less).

An infant formula test for determining whether an encapsulated product can flow through a nipple includes combining an encapsulated product with an infant formula at a ratio of 13.5 g encapsulated product to 186.5 g infant formula to produce a fortified infant formula composition. One unpacked, level scoop (approximately 8.7 g) of the fortified infant formula composition is then combined with 2 oz. (approximately 60 g) of water at several selected temperatures (e.g., 63° F., 88° F., or 200° F.) in a bottle, capped, and shaken vigorously for one minute to reconstitute the fortified infant formula composition. The cap on the bottle is then replaced with a nipple with a 0.27 mm opening, and flow through the opening of the nipple is evaluated. In order to initiate and maintain flow through the nipple, the bottle is held upside-down and the nipple is squeezed and pulled in a manner similar to milking a cow. The encapsulated product is considered to flow through a nipple with a 0.27 mm opening if the reconstituted fortified infant formula composition including the encapsulated product flows through the nipple without interruption or plugging the nipple opening when evaluated at each of 63° F., 88° F., and 200° F.

In some embodiments, an encapsulated product provided herein can be formulated for inclusion in an infant formula. For example, an encapsulated product herein can be made from ingredients suitable for use in an infant formula. Ingredients suitable for use in an infant formula can be selected from ingredients approved by a regulatory agency for use in infant formula. Examples of ingredients suitable for use in infant formula include sodium ascorbate, ascorbic acid, inositol, iron, whey, sodium caseinate, and corn starch. An encapsulated product formulated for inclusion in an infant formula flows through a nipple opening when evaluated using an infant formula test. In some embodiments, an encapsulated product formulated for inclusion in an infant formula has a fineness of 250 μm or less (e.g., 200 μm or less).

In some embodiments, an encapsulated product provided herein can be formulated for inclusion in a non-infant formula dried food product, such as an instant soup, a porridge (e.g., a baby porridge), an instant smoothie powder, a gravy mix, an instant pudding or other dessert mix, a powdered hot cocoa mix, dried instant mashed potatoes, dried milk, oat meal, and the like. An encapsulated product formulated for inclusion in a non-infant formula powdered food product has a fineness of 250 μm or less (e.g., 200 μm or less).

An encapsulated product provided herein includes a plurality of solid particles, each particle including discrete, film coated oil droplets embedded in a matrix. Film coated oil droplets can be included in a particle described herein in an amount of from 5% to 35% (e.g., about 5% to about 25%, or about 15% to about 20%) by weight of the particle. A film coated oil droplet can comprise from about 85% to about 95% by weight oil, and about 5% to about 15% by weight film. Oil droplets can include an oxidation sensitive and/or heat sensitive oil or oil soluble compound. For example, oil droplets in an encapsulated product provided herein can include a PUFA (e.g., DHA, EPA, ALA, or ARA), a monounsaturated fatty acid, an oil soluble vitamin or other oil soluble nutrient, or a combination thereof. In some embodiments, the oil droplets can be a blend of a less oxidation and/or heat sensitive oil, such as an oil high in monounsaturated fatty acid, and a more oxidation and/or heat sensitive oil or oil soluble compound, such as a PUFA. In some embodiments, an oil droplet includes 20% to 80% PUFA or a mixture of different PUFAs. For example, in some embodiments, an oil droplet can include 20% to 45% DHA, EPA, ARA, or a combination thereof. In another embodiment, an oil droplet can include 30% to 80% ALA.

Films suitable for coating oil droplets include films resulting from emulsifying an oil in water or aqueous solution in the presence of a film-forming composition, such as a soluble protein (e.g., whey or a caseinate) or a gum (e.g., gum Arabic). In some embodiments, a film-forming composition can be a non-dairy ingredient, such as a gum (e.g., gum Arabic) or a plant protein (e.g., a soy protein) with emulsifying and micro-encapsulating properties.

Film coated oil droplets are embedded in a continuous phase of a matrix. A continuous phase is included in a particle described herein in an amount of from 17% to 57% (e.g., from about 25% to about 57%, from about 28% to about 56%, or from about 30% to about 42%) by weight of the particle. A continuous phase includes a component that is plasticized during extrusion at a temperature at or below 50° C. Examples of components suitable for use in a continuous phase include a water soluble carbohydrate (e.g., a pre-gelatinized starch, maltose, maltodextrin, sucrose, lactose, or corn syrup solids), a water soluble protein (e.g., whey, a soy protein, a pea protein, or a caseinate), a water soluble gum (e.g., gum Arabic or guar gum), or a combination thereof. In order to ease production of an encapsulated product, the amount of protein in a continuous phase should be low enough to prevent plugging of an extruder die, or plugging the nipple opening of a baby bottle after reconstitution of infant formula in water. In some embodiments, the protein content of a continuous phase does not exceed 16% (e.g., not more than 10%) by weight of an encapsulated product particle.

In some embodiments, a continuous phase can include an antioxidant, such as an acidic antioxidant, or a component that improves the effect of an antioxidant. An antioxidant can be included in an amount of up to 10% (e.g., from about 3% to about 7%) by weight of an encapsulated product particle. The amount and type of antioxidant can be selected to provide a desired oxidation stability or to comply with regulatory guidelines. Examples of suitable antioxidants or components that improve the effect of an antioxidant include, without limitation, ascorbic acid, sodium ascorbate, citric acid, sodium citrate, potassium citrate, calcium citrate, erythorbic acid, and combinations thereof.

In some embodiments, a continuous phase can include a softener in an amount of from about 1% to about 7% (e.g., from about 3% to about 7%) by weight of an encapsulated product particle. Suitable softeners include, for example, glycerol, inositol, high fructose corn syrup, honey, and the like.

A matrix of an encapsulated product particle provided herein also includes a dispersed phase embedded in the continuous phase of the matrix. A dispersed phase is included in an encapsulated product particle in an amount of from 22% to 65% (e.g., from about 27% to about 65%, from about 30% to about 62%, or from about 42% to about 62%) by weight of the particle. A dispersed phase includes a component that is not plasticized during extrusion at a temperature at or below 50° C. Examples of components suitable for use in a dispersed phase include uncooked starch (e.g., a native starch or a modified starch), an insoluble fiber, an inert mineral, or other compound that is insoluble in water at a temperature at or below 50° C., or a combination thereof. Components suitable for use in a dispersed phase can have a particle size of less than 150 μm (e.g., less than 100 μm). A preferred component for a dispersed phase is an uncooked starch having a granule size of less than 100 μm. Starches having a granule size of less than 100 μm include, for example, a legume starch (e.g., pea), a grain starch (e.g., wheat, maize, rice), or a tuber starch (e.g., sweet potato, potato, tapioca).

In some embodiments, formulation of an encapsulated product particle can be adjusted to provide desired features, such as improved disintegration time, a desired fineness, or improved nipple flow. For example, if a continuous phase of a matrix is formulated to contain no protein, inclusion of glycerol in the continuous phase can be used to increase fineness. In another example, if a caseinate is used as a film to coat oil droplets, the matrix can be formulated to exclude whey protein in order to improve disintegration. In another example, glycerol or inositol can be used as a softener in particles that include whey in the matrix. In some embodiments, an encapsulated product particle can be formulated to contain no dairy ingredients (e.g., contain soy or other plant proteins).

In some embodiments, additional components can be included in an encapsulated product particle. For example, flavoring agents, color agents, and the like can be included to provide a desired appearance or flavor. Such additional components can be included in any appropriate part of the particle. For example, an oil soluble flavoring agent can be included in oil droplets. In another example, a color agent can be included in the continuous phase of a particle.

Particles of an encapsulated product provided herein can be produced by combining an oil-in-water emulsion with components of the continuous and dispersed phases of the matrix and extruding the mixture through a die. Extrusion can be performed using any suitable extruding equipment, such as, for example, a single screw or twin screw extruder. Extrusion can be performed at a temperature at or below 50° C. in order to reduce thermal degradation of a heat sensitive oil or oil soluble compound. In addition, extrusion at a temperature at or below 50° C. can avoid denaturation of matrix and film-forming composition components, and/or gelatinization of uncooked starch, which can affect the functionality of those components.

A die for extrusion of particles for an encapsulated product can be selected to produce particles sized as desired for inclusion in a dried food product. Particles can be suitably sized to have an average diameter of from about 0.15 mm to about 0.5 mm (e.g., about 0.25 mm to about 0.5 mm), with a length to diameter ratio of up to about 1.2. For example, an instant food product where a very fine particle size is desired for quick disintegration in water could have a diameter of 0.35 mm with a length to diameter ratio of less than 0.5 (e.g., less than 0.25).

An encapsulated product provided herein can be combined with any appropriate ingredients to produce a dried food product. For example, a soup mix can be produced by combining an encapsulated product provided herein with ingredients such as spices, powdered bullion, dried vegetables, and/or dry noodles, and the like. An encapsulated product provided herein including a PUFA can be combined with an infant formula product to produce an infant formula that is supplemented with the PUFA.

### EXAMPLES

### Example 1

Oil droplets were produced by emulsifying an oil containing 35% DHA in a 10% film-forming composition aqueous solution at a ratio of 50% oil to 50% film-forming composition solution. The film forming composition used in each sample is indicated in Table 1, below. The oil-in-water emulsion was then combined with a matrix dry mix that included 70% by weight uncooked, thin boiling starch as the dispersed phase and 30% continuous phase and other components (e.g., ascorbic acid and glycerol) as indicated in Table 1 in a twin screw extruder with temperatures in the extruder not exceeding 45° C. The mixture was extruded through a die with 0.35 mm die holes, and cut into particles having a length:diameter ratio of about 1 after exiting the die. Following extrusion and cutting, the particles were dried using a fluidized bed dryer for 15 to 25 minutes at an inlet air temperature of 40° C. Each of the formulations tested in Table 1 had an expected shelf life of at least 6 months at room temperature and a regular air environment based on having an Oxipres stability of at least 6 hours. Sample 1.5 had an unexpectedly high Oxipres stability of at least 45 hours.

TABLE 1

| | | | | | Nipple Flow | | Oxipres |
|---|---|---|---|---|---|---|---|
| | Continuous | | Ascorbic | | (0.27 mm | Fineness < | Stability |
| Sample | Phase | Film | Acid | Glycerol | nipple opening) | 250 μm | (hrs.) |
| 1.3 | Whey | WPC | 3.5% | 3% | No | Yes | 18.47 |
| 1.4 | Whey | WPC | 3.5% | 5% | Yes | Yes | 22.38 |
| 1.5 | Whey | WPC | 7% | 5% | Yes | Yes | 48.66 |
| 1.6 | 2:1 Pregelat | WPC | 3.5% | 5% | Intermittent | No | 6.30 |
| | Starch:Emulsif | | | | | | |
| | Starch | | | | | | |
| 1.7 | 2:1 Pregelat | NaCas | 3.5% | 5% | No | No | 8.75 |
| | Starch:Emulsif | | | | | | |
| | Starch | | | | | | |
| 1.8 | Whey | NaCas | 3.5% | 5% | No | No | 18.28 |

WPC = whey protein concentrate (82.5% protein);
Whey = functional whey protein (35% protein);
Pregelat Starch = pregelatinized starch;
Emulsif Starch = emulsifying starch;
NaCas = sodium caseinate

### Example 2

Particles including DHA oil droplets from Ex. 1 were produced using the same protocol as in Ex. 1, but using a matrix dry mix that was either 60% or 70% by weight uncooked, thin boiling starch as the dispersed phase and 30% or 40% continuous phase, and other components, as indicated in Table 2. Each of formulations 2.1-2.5 tested in Table 2 had an expected shelf life of at least 6 months at room temperature and a regular air environment based on having an Oxipres stability of at least 5.5 hours. Samples 2.6 and 2.7 resulted in plugging the die.

TABLE 2

| | Dispersed | | | | | Nipple Flow | | Oxipres |
|---|---|---|---|---|---|---|---|---|
| | Phase (% | Continuous | | | | (0.27 mm | Fineness < | Stability |
| Sample | dry mix) | Phase | Film | Antioxidant | Glycerol | nipple opening) | 250 μm | (hrs.) |
| 2.1 | 70% | Whey | WPC | AA (3.5%) | 5% | Intermittent | Yes | 24.00 |
| 2.2 | 70% | Whey | WPC | SA (3.5%) | 5% | Yes | Yes | 24.56 |
| 2.3 | 70% | 2:1 Pregelat | NaCas | AA (3.5%) | 5% | No | No | 8.96 |
| | | Starch:Emulsif | | | | | | |
| | | Starch | | | | | | |
| 2.4 | 70% | 2:1 Pregelat | NaCas | AA (7%) | 5% | Yes | No | 5.79 |
| | | Starch:Emulsif | | | | | | |
| | | Starch | | | | | | |
| 2.5 | 60% | 2:1:1 Pregelat | NaCas | AA (7%) | 5% | Intermittent | Yes | 14.72 |
| | | Starch:Emulsif | | | | | | |
| | | Starch:Maltodex | | | | | | |
| 2.6 | 70% | Whey | WPC | SA (7%) | 5% | NA | NA | NA |
| 2.7 | 60% | 3:1 | WPC | SA (7%) | 5% | NA | NA | NA |
| | | Whey:Maltodex | | | | | | |

AA = ascorbic acid;
SA = sodium ascorbate;
Maltodex = maltodextrin;
WPC = whey protein concentrate (82.5% protein);
Whey = functional whey protein (35% protein);
Pregelat Starch = pregelatinized starch;
Emulsif Starch = emulsifying starch;
NaCas = sodium caseinate;
NA = not applicable, plugged die

### Example 3

Particles including DHA oil droplets from Ex. 1 were produced using the same protocol as in Ex. 1, but using a matrix dry mix that was either 50% or 70% by weight uncooked, thin boiling starch as the dispersed phase and 30% or 50% continuous phase, and other components, as indicated in Table 3. Each of formulations 3.1-3.7 tested in Table 3 had an expected shelf life of at least 6 months at room temperature and a regular air environment based on having an Oxipres stability of at least 6 hours. Samples 3.8, 3.9, and 3.10 plugged the die.

TABLE 3

| | Dispersed | | | | | Nipple Flow | | Oxipres |
|---|---|---|---|---|---|---|---|---|
| | Phase (% | Continuous | | Ascobic | | (0.27 mm | Fineness < | Stability |
| Sample | dry mix) | Phase | Film | acid | Polyol | nipple opening) | 250 μm | (hrs.) |
| 3.1 | 70% | Whey | WPC | 3.5% | 5% Gly | Yes | Yes | 22.35 |
| 3.2 | 70% | Whey | WPC | 3.5% | 5% Inos | Yes | Yes | 18.65 |
| 3.3 | 70% | WPC | WPC | 3.5% | 5% Gly | Intemittent | No | 6.80 |
| 3.5 | 50% | 3:2 Whey:Pregelat | WPC | 3.5% | 5% Gly | Yes | Yes | 6.97 |
| | | starch | | | | | | |
| 3.6 | 70% | 2:1 Pregelat | NaCas | 3.5% | 7.5% Gly | No | No | 10.99 |
| | | starch:Emulsif | | | | | | |
| | | Starch | | | | | | |
| 3.7 | 70% | 2:1 Pregelat | NaCas | 3.5% | 10% Gly | Intermittent | No | 11.60 |
| | | starch:Emulsif | | | | | | |
| | | Starch | | | | | | |
| 3.8 | 50% | Whey | WPC | 3.5% | 5% Gly | NA | NA | NA |
| 3.9 | 50% | Whey | WPC | 7% | 5% Gly | NA | NA | NA |
| 3.10 | 50% | WPC | WPC | 3.5% | 5% Gly | NA | NA | NA |

WPC = whey protein concentrate (82.5% protein);
Whey = functional whey protein (35% protein);
Pregelat Starch = pregelatinized starch;
Emulsif Starch = emulsifying starch;
NaCas = sodium caseinate;
Gly = glycerol;
Inos = inositol;
NA = not applicable, plugged die

### Example 4

Particles including oil droplets that included DHA, ARA, or a combination of DHA and ARA were produced using the same protocol as in Ex. 1, but using a matrix dry mix that was either 60% or 70% by weight uncooked, thin boiling starch as the dispersed phase and 30% or 40% continuous phase as indicated in Table 4. Each of formulations tested in Table 4 had an expected shelf life of at least 6 months at room temperature and a regular air environment based on having an Oxipres stability of at least 6 hours.

TABLE 4

| | Dispersed | | | | | Nipple Flow | | Oxipres |
|---|---|---|---|---|---|---|---|---|
| | Phase (% | Contiuous | | Ascobic | | (0.27 mm | Fineness < | Stability |
| Sample | dry mix) | Phase | Film | acid | Inositol | nipple opening) | 250 μm | (hrs.) |
| 4.1 | 60% | 3:1 Pregelat | NaCas | 7% | 5% | Intermittent | No | 8.33 |
| | | starch:Maltodex | | | | | | |
| 4.2 | 60% | 3:1 Pregelat | NaCas | 7% | 5% | Intermittent | No | 6.18 |
| | | starch:Maltodex | | | | | | |
| 4.3 | 60% | 3:1 Pregelat | NaCas | 7% | 5% | Intermittent | No | 9.76 |
| | | starch:Maltodex | | | | | | |
| 4.4 | 60% | 3:1 Pregelat | NaCas | 7% | 5% | Intermittent | No | 7.41 |
| | | starch:Maltodex | | | | | | |
| 4.5 | 70% | Whey | WPC | 3.5% | 5% | Intermittent | Yes | 13.49 |
| 4.6 | 70% | Whey | WPC | 3.5% | 5% | Yes | Yes | 21.26 |
| 4.7 | 70% | Whey | WPC | 3.5% | 5% | Intermittent | Yes | 17.49 |
| 4.8 | 70% | Whey | WPC | 3.5% | 5% | Yes | Yes | 16.44 |

WPC = whey protein concentrate (82.5% protein);
Whey = functional whey protein (35% protein);
Pregelat Starch = pregelatinized starch;
Emulsif Starch = emulsifying starch;
NaCas = sodium caseinate;
NA = not applicable, plugged die

### Example 5

In order to test whether an encapsulated product provided herein can be included in a dried food product without substantially segregating from other dried ingredients to result in a non-homogeneous mixture, two samples from Table 4 were tested to see if the pellets would segregate from a dried infant formula. Each of the samples was combined and thoroughly mixed with a dried infant formula at a ratio of about 57 g to about 60 g particles to about 940 g to about 943 g infant formula to produce two 1 kg enriched infant formula samples, each containing one of the encapsulated product samples. The proportion of coarse granules (>250 μm) in each enriched infant formula sample, which contained the encapsulated product samples and particles from the dried infant formula, and the proportion of fines (<250 μm) in each enriched infant formula sample were measured and recorded.

Next, a representative 100 g sample of each of the enriched infant formula samples was checked to make sure of the correct proportion of encapsulated product could be found in the sample (Table 5).

Then, 750 g of each of the enriched infant formula samples was placed in a separate metal infant formula container (from which the original infant formula was taken) and the lid closed. The infant formula containers were shaken in an upright position on an 18 inch round vibratory separator (SWECO Americas, Florence, Ky., USA) for 5 minutes. After each container was shaken, a 100 g sample of each of the enriched infant formula samples was taken from the top, the middle, and the bottom of the containers and sifted using a Ro-Tap test sieve shaker with a 250 μm screen. The proportion of coarse granules and fines from each of the top, middle and bottom samples was measured and recorded, and compared to the proportions after mixing. Table 5 shows that neither encapsulated product sample settled out of the enriched infant formulas after shaking.

TABLE 5

| | | | Sample 1 | Sample 2 |
|---|---|---|---|---|
| After Mixing | 100 g sample | Coarse (g) | 12.6 | 10.1 |
| | | Fines (g) | 86.9 | 90.0 |
| | | Total (g) | 99.5 | 100.1 |
| After Shaking | Top (100 g) | Coarse (g) | 12.0 | 10.2 |
| | | Fines (g) | 87.4 | 89.5 |
| | | Total (g) | 99.4 | 99.7 |
| | Middle (100 g) | Coarse (g) | 12.7 | 10.0 |
| | | Fines (g) | 85.9 | 90.1 |
| | | Total (g) | 98.6 | 100.1 |
| | Bottom (100 g) | Coarse (g) | 13.1 | 10.0 |
| | | Fines (g) | 85.6 | 89.7 |
| | | Total (g) | 98.7 | 99.7 |

### Example 6—Comparative Example

Particles with an 80:20 durum wheat:wheat protein matrix were produced to test fineness and nipple flow as compared to particles, as described above. Durum wheat contains approximately 70% starch, in order to contribute to a dispersed phase that is approximately 56% of the matrix in ungelatinized starch form. Particles including DHA oil droplets from Ex. 1 were produced using a similar protocol as in Ex. 1, except that the mixture was cut into particles having a length:diameter ratio of about 0.5 after exiting the die rather than a length:diameter ratio of about 1. The composition of the particles is provided in Table 6.

TABLE 6

| | |
|---|---|
| Dispersed phase | ~56% by weight dry mix ungelatinized |
| | starch from durum wheat flour |
| Continuous phase | ~44% by weight dry mix |
| Film | NaCas |
| Antioxidant | AA (3%), SA (4%) |
| Glycerol | 15% |
| Nipple Flow (0.27 mm nipple | No |
| opening) | |
| Fineness <250 μm | No |

AA = ascorbic acid;
SA = sodium ascorbate;
NaCas = sodium caseinate

Despite being of a smaller size and having a matrix with a polyol content that is higher than the samples in Examples 1-4, which would have been expected to soften the particles, particles made with the 80:20 durum wheat:wheat protein matrix did not disintegrate substantially after a prolonged period of time in water. As can be seen in Table 6, particles containing a durum wheat and wheat protein matrix did not have a fineness of less than 250 μm when evaluated using the infant formula fineness test or flow through a nipple having a 0.27 mm opening when evaluated using an infant formula nipple flow test.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. An encapsulated product comprising solid particles having an average diameter of 0.15-0.5 mm, with a length to diameter ratio of up to 1.2, each particle including:
discrete, film coated oil droplets in an amount of from 5% to 25% by weight of the particle; and
a matrix having:
a continuous phase in an amount of from 25% to 57% by weight of the particle, the continuous phase including a water soluble carbohydrate, a water soluble protein, a water soluble gum, or a combination thereof, the protein content of the continuous phase comprising no more than 16% by weight of the particle, and
a dispersed phase including an uncooked starch, an insoluble fiber, or a combination thereof in an amount of from 27% to 65% by weight of the particle,
the continuous phase having embedded in it discrete pieces of the dispersed phase and the film coated oil droplets,
wherein the encapsulated product has a fineness of less than 250 μm when evaluated using the infant formula fineness test or flows through a nipple having a 0.27 mm opening when evaluated using an infant formula nipple flow test.

2. The encapsulated product of claim 1, wherein the continuous phase further comprises a softener selected from glycerol, inositol, high fructose corn syrup, honey, and a combination thereof in an amount of about 1-7% by weight of the particle.

3. The encapsulated product of claim 1, wherein the continuous phase further comprises an antioxidant or component that improves the effect of an antioxidant selected from ascorbic acid, sodium ascorbate, citric acid, sodium citrate, potassium citrate, calcium citrate, erythorbic acid, and combinations thereof.

4. The encapsulated product of claim 1, wherein the continuous phase comprises pre-gelatinized starch, maltodextrin, whey protein, a caseinate, or a combination thereof.

5. The encapsulated product of claim 1, wherein the film of the film coated droplets comprises whey protein, a caseinate, a plant protein, a gum, or a combination thereof.

6. The encapsulated product of claim 1, wherein the continuous phase comprises whey protein, and the film of the film coated oil droplets contains substantially no caseinate.

7. The encapsulated product of claim 1, wherein the continuous phase comprises whey protein, and includes inositol in an amount of about 1-7% by weight of the particle.

8. The encapsulated product of claim 1, wherein the continuous phase comprises a water soluble carbohydrate, and includes glycerol in an amount of about 1-7% by weight of the particle, and contains substantially no protein.

9. The encapsulated product of claim 1, wherein the dispersed phase includes an uncooked starch that is a thin boiling starch.

10. The encapsulated product of claim 1, wherein the dispersed phase includes an uncooked starch that has a granule size of less than 100 nm.

11. The encapsulated product of claim 1, wherein the oil droplets comprise docosahexaenoic acid (DHA), arachidonic acid (ARA), eicosapentaenoic acid (EPA), alpha-linolenic acid (ALA), an oil-soluble vitamin, or a combination thereof.

12. The encapsulated product of claim 1, wherein the matrix includes no fat component.

13. The encapsulated product of claim 1, wherein the fineness of the product when evaluated using the infant formula fineness test is less than 200 μm.

14. The encapsulated product of claim 1, wherein the product flows through a nipple having a 0.27 mm opening when evaluated using the infant formula nipple flow test.

15. The encapsulated product of claim 1, wherein the encapsulated product contains no dairy ingredients.

16. A powdered instant dry food product comprising the encapsulated product of claim 1.

17. The powdered instant dry food product of claim 16, wherein the powdered instant dry food product is selected from an infant formula, a dry soup mix, a gravy mix, an instant dried mashed potato, an instant pudding or other instant dessert mix, a porridge, a baby porridge, an instant smoothie powder mix, a hot cocoa mix, dry milk, and oat meal.

18. (canceled)

19. The encapsulated product of claim 1, wherein:
the discrete, film coated oil droplets are included in an amount of from 5% to 20% by weight of the particle;
the matrix has the continuous phase in an amount of from 30% to 42% by weight of the particle, the protein content of the continuous phase comprising no more than 10% by weight of the particle; and
the dispersed phase includes the uncooked starch in an amount of from 42% to 62% by weight of the particle.

20. The encapsulated product of claim 19, wherein the encapsulated product has an Oxipres stability that is at least 13 hours.

21. The encapsulated product of claim 19, wherein the encapsulated product has an Oxipres stability that is at least 18 hours.

22-24. (canceled)

25. The encapsulated product of claim 1, wherein
the film coating the oil droplets comprises whey or a caseinate, and wherein the
continuous phase includes
the water soluble carbohydrate, the water soluble protein,
the water soluble gum, or the combination thereof when the film comprises whey; or
a pregelatinized starch, the water soluble protein, the water soluble gum, or a combination thereof, and substantially no whey protein when the film comprises a caseinate.

26-28. (canceled)

29. An encapsulated product comprising solid particles having an average diameter of 0.15-0.5 mm, with a length to diameter ratio of up to 1.2, each particle including:
discrete, film coated oil droplets in an amount of from 5% to 35% by weight of the particle; and
a matrix having:
a continuous phase in an amount of from 17% to 57% by weight of the particle, the continuous phase including a water soluble carbohydrate, a water soluble protein, a water soluble gum, or a combination thereof, the protein content of the continuous phase comprising no more than 16% by weight of the particle, and
a dispersed phase including a component that is not plasticized during extrusion at a temperature at or below 50° C., the dispersed phase included in an amount of from 22% to 65% by weight of the particle,
the continuous phase having embedded in it discrete pieces of the dispersed phase and the film coated oil droplets,
wherein the encapsulated product has a fineness of less than 250 μm when evaluated using the infant formula fineness test or flows through a nipple having a 0.27 mm opening when evaluated using an infant formula nipple flow test.

30. An encapsulated product comprising solid particles having an average diameter of 0.15-0.5 mm, with a length to diameter ratio of up to 1.2, each particle including:
discrete, film coated oil droplets; and
a matrix having:
a continuous phase, the continuous phase including a water soluble carbohydrate, a water soluble protein, a water soluble gum, or a combination thereof, and
a dispersed phase including a component that is not plasticized during extrusion at a temperature at or below 50° C.,
the continuous phase having embedded in it discrete pieces of the dispersed phase and the film coated oil droplets,
wherein the encapsulated product has a fineness of less than 250 μm when evaluated using the infant formula fineness test or flows through a nipple having a 0.27 mm opening when evaluated using an infant formula nipple flow test.

31. The encapsulated product of claim 30, wherein the oil content is from 5% to 35%, the continuous phase is in an amount of from 17% to 57%, and the dispersed phase is in an amount of from 22% to 65%.

32. The encapsulated product of claim 30, wherein the continuous phase is in an amount of from 25% to 57% by weight of the particle, and the dispersed phase is in an amount of from 27% to 65% by weight of the particle.
